(19) United States
(12) Patent Application Publication
(10) Pub. No.: US 2013/0055147 A1
(43) Pub. Date: Feb. 28, 2013

(54) CONFIGURATION, GENERATION, AND PRESENTATION OF CUSTOM GRAPHICAL USER INTERFACE COMPONENTS FOR A VIRTUAL CLOUD-BASED APPLICATION

(71) Applicants: Gautam Vasudev, San Francisco, CA (US); Jason Ellis, Geneva, IL (US); Michael Ramsey, Foster City, CA (US); Peng-Wen Chen, Foster City, CA (US)

(72) Inventors: Gautam Vasudev, San Francisco, CA (US); Jason Ellis, Geneva, IL (US); Michael Ramsey, Foster City, CA (US); Peng-Wen Chen, Foster City, CA (US)

(73) Assignee: SALESFORCE.COM, INC., San Francisco, CA (US)

(21) Appl. No.: 13/403,913

(22) Filed: Feb. 23, 2012

Related U.S. Application Data
(60) Provisional application No. 61/528,317, filed on Aug. 29, 2011.

(51) Int. Cl. G06F 3/048

(52) U.S. Cl. 715/781; 715/764

(57) ABSTRACT

A method of presenting information associated with an application begins by providing a graphical user interface (GUI) for display at a user device. The GUI includes a primary GUI element and a secondary GUI element. The content of the primary GUI element is contextually related to the content of the secondary GUI element. The method continues by detecting changes made to the primary content resulting from user interaction with the primary GUI element, and, in response to detecting the changes, refreshing the secondary GUI element to update the secondary content.

### CROSS-REFERENCE TO RELATED APPLICATION

This application claims the benefit of U.S. provisional patent application Ser. No. 61/528,317, filed Aug. 29, 2011, the content of which is incorporated by reference herein.

### TECHNICAL FIELD

Embodiments of the subject matter described herein relate generally to data processing systems and techniques, such as systems and processes that use a common network-based platform to support applications executing on behalf of multiple tenants. More particularly, embodiments of the subject matter relate to the generation and presentation of a secondary graphical user interface (GUI) element alongside a primary GUI element, where the content of the secondary GUI is related to, supplements, or is otherwise associated with the content of the primary GUI element.

### BACKGROUND

Modern software development is evolving away from the client-server model toward network-based processing systems that provide access to data and services via the Internet or other networks. In contrast to traditional systems that host networked applications on dedicated server hardware, a “cloud” computing model allows applications to be provided over the network “as a service” supplied by an infrastructure provider. The infrastructure provider typically abstracts the underlying hardware and other resources used to deliver a custom-developed application so that the customer no longer needs to operate and support dedicated server hardware. The cloud computing model can often provide substantial cost savings to the customer over the life of the application because the customer no longer needs to provide dedicated network infrastructure, electrical and temperature controls, physical security and other logistics in support of dedicated server hardware.

Multi-tenant cloud-based architectures have been developed to improve collaboration, integration, and community-based cooperation between customer tenants without sacrificing data security. Generally speaking, multi-tenancy refers to a system wherein a single hardware and software platform simultaneously supports multiple user groups (also referred to as “organizations” or “tenants”) from a common data store. The multi-tenant design provides a number of advantages over conventional server virtualization systems. First, the multi-tenant platform operator can often make improvements to the platform based upon collective information from the entire tenant community. Additionally, because all users in the multi-tenant environment execute applications within a common processing space, it is relatively easy to grant or deny access to specific sets of data for any user within the multi-tenant platform, thereby improving collaboration and integration between applications and the data managed by the various applications. The multi-tenant architecture therefore allows convenient and cost effective sharing of similar application features between multiple sets of users.

A customer relationship management (CRM) application may be deployed using a multi-tenant architecture. A CRM application can be used to track sales activity, the progression of potential sales deals, sales team quotas, and the like, using various GUI screens, pages, and elements. For example, a CRM application may generate and display a variety of primary views, pages, or screens that provide relevant information, such as a “Case Detail” view, an “Account Detail” view, an “Opportunity Detail” view, a “Contact Detail” view, or the like. These primary views typically represent common or frequently used GUIs that together form the core functionality of the CRM application.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is a schematic representation of an exemplary embodiment of a multi-tenant application system;

FIG. 2 depicts an exemplary GUI display that could be generated within a web browser on a client computing device in the system shown in FIG. 1;

FIGS. 3-6 are diagrams that illustrate customizable characteristics of a secondary GUI element suitable for use in a GUI generated within a web browser on a client computing device in the system shown in FIG. 1;

FIG. 7 is a diagram that illustrates an exemplary GUI display that includes a primary GUI element for primary content and multiple secondary GUI elements for secondary content, where the secondary GUI elements are arranged in a vertically expandable arrangement;

FIG. 8 is a diagram that illustrates an exemplary GUI display that includes a primary GUI element for primary content and multiple secondary GUI elements for secondary content, where the secondary GUI elements are arranged in a horizontal tabbed arrangement;

FIG. 9 is a flow chart that illustrates an exemplary embodiment of a custom sidebar configuration process; and

FIG. 10 is a flow chart that illustrates an exemplary embodiment of a custom sidebar presentation process.

### DETAILED DESCRIPTION

The exemplary embodiments presented here relate to various techniques for processing and presenting information in the context of the use and manipulation of GUIs, web pages, and interactive displays associated with a computer-implemented system or application, such as a software-based system, a database system, a multi-tenant environment, or the like. The described subject matter could be implemented in connection with two or more separate and distinct computer-implemented systems that cooperate and communicate with one another, e.g., a client (end user) system and a server or cloud-based system. Although the subject matter presented here could be utilized in connection with any type of GUI-based application, the exemplary embodiments described here can be implemented in conjunction with a virtual customer relationship management (CRM) application in a multi-tenant environment.

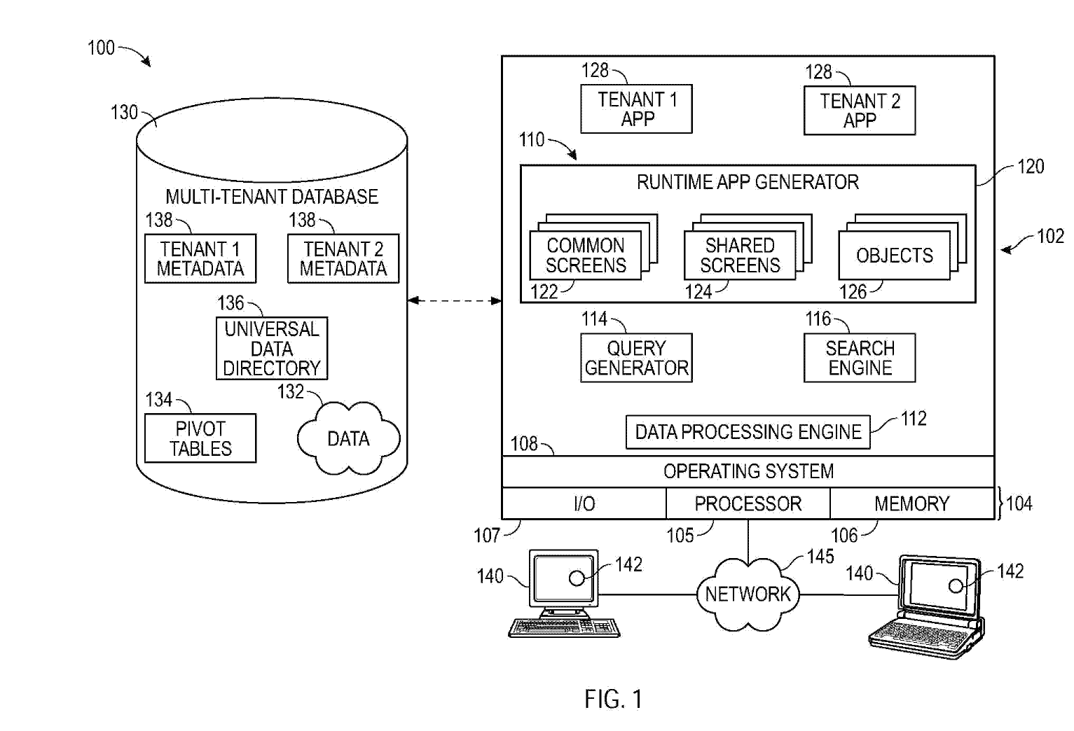

Turning now to FIG. 1, an exemplary multi-tenant application system 100 suitably includes a server 102 that dynamically creates virtual applications 128 based upon data 132 from a common database 130 that is shared between multiple tenants. Data and services generated by the virtual applications 128 are provided via a network 145 to any number of user devices 140, as desired. Each virtual application 128 is suitably generated at run-time using a common application platform 110 that securely provides access to the data 132 in the database 130 for each of the various tenants subscribing to the system 100. In accordance with one non-limiting example, the system 100 may be implemented in the form of a multi-tenant CRM system that can support any number of authenticated users of multiple tenants.

A “tenant” or an “organization” generally refers to a group of users that shares access to common data within the database 130. Tenants may represent customers, customer departments, business or legal organizations, and/or any other entities that maintain data for particular sets of users within the system 100. Although multiple tenants may share access to the server 102 and the database 130, the particular data and services provided from the server 102 to each tenant can be securely isolated from those provided to other tenants. The multi-tenant architecture therefore allows different sets of users to share functionality without necessarily sharing any of the data 132.

The database 130 is any sort of repository or other data storage system capable of storing and managing the data 132 associated with any number of tenants. The database 130 may be implemented using any type of conventional database server hardware. In various embodiments, the database 130 shares processing hardware 104 with the server 102. In other embodiments, the database 130 is implemented using separate physical and/or virtual database server hardware that communicates with the server 102 to perform the various functions described herein.

The data 132 may be organized and formatted in any manner to support the application platform 110. In various embodiments, the data 132 is suitably organized into a relatively small number of large data tables to maintain a semi-amorphous “heap”-type format. The data 132 can then be organized as needed for a particular virtual application 128. In various embodiments, conventional data relationships are established using any number of pivot tables 134 that establish indexing, uniqueness, relationships between entities, and/or other aspects of conventional database organization as desired.

Further data manipulation and report formatting is generally performed at run-time using a variety of metadata constructs. Metadata within a universal data directory (UDD) 136, for example, can be used to describe any number of forms, reports, workflows, user access privileges, business logic and other constructs that are common to multiple tenants. Tenant-specific formatting, functions and other constructs may be maintained as tenant-specific metadata 138 for each tenant, as desired. Rather than forcing the data 132 into an inflexible global structure that is common to all tenants and applications, the database 130 is organized to be relatively amorphous, with the pivot tables 134 and the metadata 138 providing additional structure on an as-needed basis. To that end, the application platform 110 suitably uses the pivot tables 134 and/or the metadata 138 to generate “virtual” components of the virtual applications 128 to logically obtain, process, and present the relatively amorphous data 132 from the database 130.

The server 102 is implemented using one or more actual and/or virtual computing systems that collectively provide the dynamic application platform 110 for generating the virtual applications 128. The server 102 operates with any sort of conventional processing hardware 104, such as a processor 105, memory 106, input/output features 107 and the like. The processor 105 may be implemented using one or more of microprocessors, microcontrollers, processing cores and/or other computing resources spread across any number of distributed or integrated systems, including any number of “cloud-based” or other virtual systems. The memory 106 represents any non-transitory short or long term storage capable of storing programming instructions for execution on the processor 105, including any sort of random access memory (RAM), read only memory (ROM), flash memory, magnetic or optical mass storage, and/or the like. The server 102 typically includes or cooperates with some type of computer-readable media, where a tangible computer-readable medium has computer-executable instructions stored thereon. The computer-executable instructions, when read and executed by the server 102, cause the server 102 to perform certain tasks, operations, functions, and processes described in more detail herein. In this regard, the memory 106 may represent one suitable implementation of such computer-readable media. Alternatively or additionally, the server 102 could receive and cooperate with computer-readable media (not separately shown) that is realized as a portable or mobile component or platform, e.g., a portable hard drive, a USB flash drive, an optical disc, or the like.

The input/output features 107 represent conventional interfaces to networks (e.g., to the network 145, or any other local area, wide area or other network), mass storage, display devices, data entry devices and/or the like. In a typical embodiment, the application platform 110 gains access to processing resources, communications interfaces and other features of the processing hardware 104 using any sort of conventional or proprietary operating system 108. As noted above, the server 102 may be implemented using a cluster of actual and/or virtual servers operating in conjunction with each other, typically in association with conventional network communications, cluster management, load balancing and other features as appropriate.

The application platform 110 is any sort of software application or other data processing engine that generates the virtual applications 128 that provide data and/or services to the user devices 140. The virtual applications 128 are typically generated at run-time in response to queries received from the user devices 140. For the illustrated embodiment, the application platform 110 includes a bulk data processing engine 112, a query generator 114, a search engine 116 that provides text indexing and other search functionality, and a runtime application generator 120. Each of these features may be implemented as a separate process or other module, and many equivalent embodiments could include different and/or additional features, components or other modules as desired.

The runtime application generator 120 dynamically builds and executes the virtual applications 128 in response to specific requests received from the user devices 140. The virtual applications 128 created by tenants are typically constructed in accordance with the tenant-specific metadata 138, which describes the particular tables, reports, interfaces and/or other features of the particular application. In various embodiments, each virtual application 128 generates dynamic web content (including GUIs, detail views, secondary or sidebar views, and the like) that can be served to a browser or other client program 142 associated with its user device 140, as appropriate.

The runtime application generator 120 suitably interacts with the query generator 114 to efficiently obtain multi-tenant data 132 from the database 130 as needed. In a typical embodiment, the query generator 114 considers the identity of the user requesting a particular function, and then builds and executes queries to the database 130 using system-wide metadata 136, tenant specific metadata 138, pivot tables 134, and/or any other available resources. The query generator 114 in this example therefore maintains security of the common database 130 by ensuring that queries are consistent with access privileges granted to the user that initiated the request.

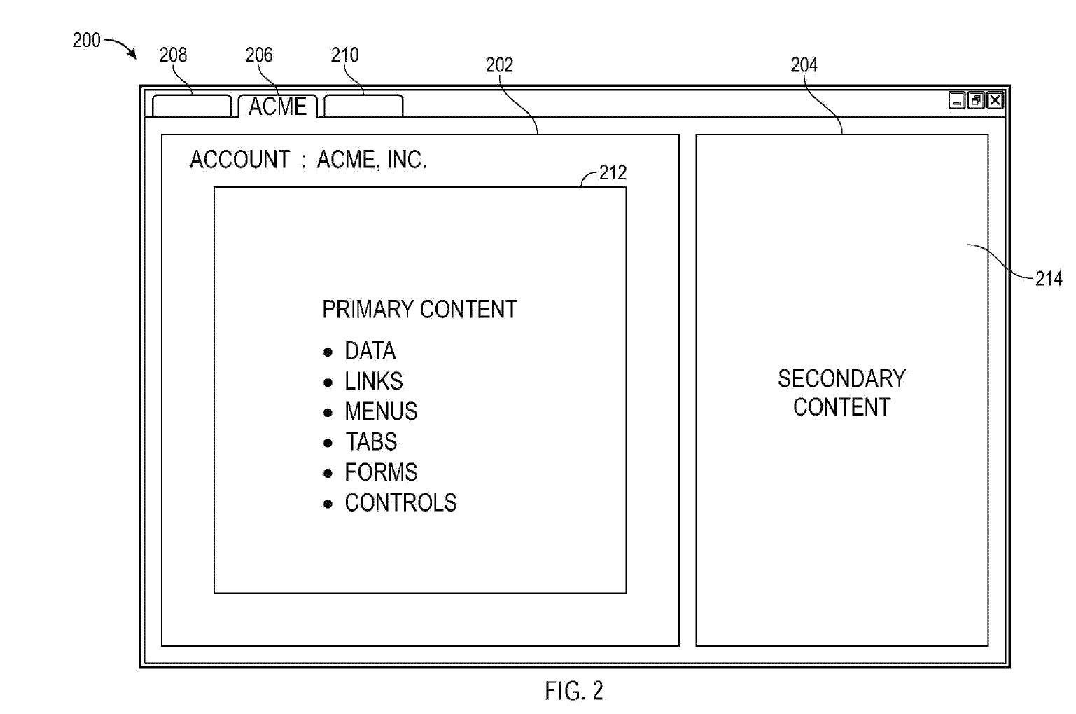

The data processing engine 112 performs bulk processing operations on the data 132 such as uploads or downloads, updates, online transaction processing, and/or the like. In many embodiments, less urgent bulk processing of the data 132 can be scheduled to occur as processing resources become available, thereby giving priority to more urgent data processing by the query generator 114, the search engine 116, the virtual applications 128, etc. In certain embodiments, the data processing engine 112 and the processor 105 cooperate in an appropriate manner to perform and manage various techniques, processes, and methods associated with the generation, provision, manipulation and/or operation of GUIs and GUI elements, as described in more detail below with reference to FIGS. 2-10.

In operation, developers use the application platform 110 to create data-driven virtual applications 128 for the tenants that they support. Such virtual applications 128 may make use of interface features such as tenant-specific screens 124, universal screens 122 or the like. Any number of tenant-specific and/or universal objects 126 may also be available for integration into tenant-developed virtual applications 128. The data 132 associated with each virtual application 128 is provided to the database 130, as appropriate, and stored until it is requested or is otherwise needed, along with the metadata 138 that describes the particular features (e.g., reports, tables, functions, etc.) of that particular tenant-specific virtual application 128. For example, a virtual application 128 may include a number of objects 126 accessible to a tenant, wherein for each object 126 accessible to the tenant, information pertaining to its object type along with values for various fields associated with that respective object type are maintained as metadata 138 in the database 130. In this regard, the object type defines the structure (e.g., the formatting, functions and other constructs) of each respective object 126 and the various fields associated therewith. In an exemplary embodiment, each object type includes one or more fields for indicating the relationship of a respective object of that object type to one or more objects of a different object type (e.g., master-detail, lookup relationships, or the like).

As described in greater detail below in the context of FIGS. 2-10, in exemplary embodiments, the application platform 110, the data processing engine 112, the query generator 114, and the processor 105 cooperate in an appropriate manner to process data associated with a hosted virtual application 128 (such as a CRM application), generate and provide suitable GUIs (such as web pages) for presenting data on client devices 140, and perform additional techniques, processes, and methods to support the features and functions related to the management and presentation of primary and secondary views for the hosted virtual application 128.

Still referring to FIG. 1, the data and services provided by the server 102 can be retrieved using any sort of personal computer, mobile telephone, portable device, tablet computer, or other network-enabled user device 140 that communicates via the network 145. Typically, the user operates a conventional browser or other client program 142 to contact the server 102 via the network 145 using, for example, the hypertext transport protocol (HTTP) or the like. The user typically authenticates his or her identity to the server 102 to obtain a session identifier (“SessionID”) that identifies the user in subsequent communications with the server 102. When the identified user requests access to a virtual application 128, the runtime application generator 120 suitably creates the application at run time based upon the metadata 138, as appropriate. The query generator 114 suitably obtains the requested data 132 from the database 130 as needed to populate the tables, reports or other features of the particular virtual application 128. As noted above, the virtual application 128 may contain Java, ActiveX, or other content that can be presented using conventional client software running on the user device 140; other embodiments may simply provide dynamic web or other content that can be presented and viewed by the user, as desired.

As mentioned above, a user of a client device 140 can access, manipulate, and otherwise interact with a virtual application hosted by a cloud-based system, such as a multi-tenant architecture of the type described previously. In certain non-limiting embodiments, a web browser of a client device 140 can be utilized to access, manipulate, and otherwise interact with a hosted customer relationship management (CRM) application. The virtual application may be configured to generate and provide any number of GUIs, GUI elements, web pages, resources, and/or displays as needed to support the desired functionality. For the exemplary embodiments presented here, GUI displays and screens are configured for rendering as web pages such that the GUI displays and screens can be presented in a conventional manner using a web browser running on a client device 140. In this regard, FIG. 2 depicts an exemplary GUI display 200 that could be generated within a web browser on a client device 140 in the system 100 shown in FIG. 1.

The GUI display 200 depicted in FIG. 2 includes, without limitation, a primary GUI element 202 and a secondary GUI element 204, which are concurrently rendered and displayed together as shown in FIG. 2. It should be appreciated that the precise layout of the GUI elements 202, 204, the shapes and sizes of the GUI elements 202, 204, the particular display characteristics of the GUI elements 202, 204, and possibly other variable aspects of the GUI display 200 may vary from one embodiment to another. In addition, the actual content contained in the GUI elements 202, 204 may vary from one embodiment to another, from one multi-tenant system to another, and may vary in accordance with the particular functionality of the virtual application. Indeed, the number of options, configurable display characteristics, type of content, and arrangement of information in the GUI elements 202, 204 need not be restricted or limited in any way. For this reason, FIG. 2 depicts the GUI display 200 in a rather generic form that is intended to represent the highly flexible and variable nature of the GUI display 200. In practice, the GUI display 200 could include any number of additional GUI elements, features, components, functionality, or the like. For the sake of brevity and clarity, FIG. 2 is void of such additional elements.

The primary GUI element 202 represents the main view, page, or window that is currently selected, highlighted, or focused. The exemplary embodiment shown in FIG. 2 indicates that the primary GUI element 202 corresponds to a selected tab 206, where three different tabs are available to the user. For this particular example, the primary GUI element 202 includes a detail view for a database object of a CRM application. In particular, the illustrated primary GUI element 202 is associated with an “Account” detail view (for the account named “Acme, Inc.”). Thus, selection of the tab 206 causes the primary GUI element 202 and the associated secondary GUI element 204 to be displayed. Selection of the tab 208 may result in the display of a different GUI display, and selection of the tab 210 may result in the display of yet another GUI display.

The primary GUI element 202 is populated with primary content 212 that is related to, associated with, relevant to, or otherwise linked to the Acme, Inc. account. The primary content 212 may include any type of information (static, dynamic, read-only, active, or the like). For example, the primary content 212 could include any or all of the following, without limitation: data; active links to online resources, web pages, or database objects; menus; tabs; forms; controls; or the like. Some or all of the primary content could be revised, changed, modified, deleted, and/or supplemented by the user via manipulation with the primary GUI element 202 and/or via manipulation with the web browser application itself. In this regard, the GUI display 200 may accommodate user-entered data for purposes of making changes or otherwise modifying the primary content.

The secondary GUI element 204 is populated with secondary content 214 that is contextually related to the primary content in some way. For example, some or all of the secondary content 214 may be influenced by, determined by, or controlled by some or all of the primary content 212. In practice, the secondary content 214 is associated with, linked to, or dependent on the primary content 212 such that the secondary content 214 supplements and enhances the primary content 212 without interfering with or obscuring the primary content 212 itself. For this particular example, the secondary GUI element 204 includes a sidebar component or a sidebar view that is associated with a database object of a CRM application. Consequently, for this example the secondary content 214 will also be related to, associated with, relevant to, or otherwise linked to the Acme, Inc. account. The secondary content 214 may include any type of information, including that described above for the primary content 212. Moreover, some or all of the secondary content could be revised, changed, modified, deleted, and/or supplemented by the user via manipulation with the secondary GUI element 204 and/or via manipulation with the web browser application itself. In this regard, the GUI display 200 may accommodate user-entered data for purposes of making changes or otherwise modifying the secondary content. In certain implementations, some or all of the secondary content is provided by a third party (i.e., an entity other than the entity that maintains and provides the hosted application). In such implementations, the secondary content can be pushed to the host system as needed to update the secondary GUI element 204. Thus, changes and modifications to the secondary content need not be the result of user interaction with the GUI display 200.

For certain exemplary embodiments, the primary GUI element 202 and the primary content 212 are associated with a first domain. The first domain may, for example, be associated with a first entity (such as the entity that maintains and provides the hosted application and the primary content 212). Thus, the user manipulates the client device such that the web browser is directed to a web page associated with the first domain (e.g., by providing a uniform resource locator (URL) or another network address associated with the first domain) to establish communication with the first domain. The web browser accesses and/or downloads the desired page (or hypertext markup language (HTML) document) available at the addressed location on the first domain, and displays or otherwise presents the content of that web page in association with the primary GUI element 202.

This description assumes that the secondary GUI element 204 and the secondary content 214 are associated with a second domain that is different than the first domain. The second domain may, for example, be associated with a second entity or any third party other than the entity that maintains and provides the hosted application and the primary content 212. Indeed, the secondary content may be maintained by a third party source or entity in a manner that is independent of the primary content. In practice, the web browser application may be directed to a web page associated with the second domain (e.g., by providing a URL or another network address associated with the second domain) to establish communication with the second domain. The web browser accesses and/or downloads the desired page (or HTML document) available at the addressed location on the second domain, and displays or otherwise presents the content of that web page in association with the secondary GUI element 204. In an exemplary embodiment, therefore, the GUI display 200 presented within the web browser on the client computing device includes primary content 212 obtained from (or associated with) the first domain, along with secondary content 214 obtained from (or associated with) the second domain. This can be accomplished by configuring and formatting the secondary GUI element 204 as an inline frame (e.g., an HTML iframe element) within the page corresponding to the primary GUI element 202. Of course, the specific manner in which the secondary GUI element 204 is configured, implemented, and rendered may vary from one embodiment to another, and techniques other than HTML iframes may be employed in this context.

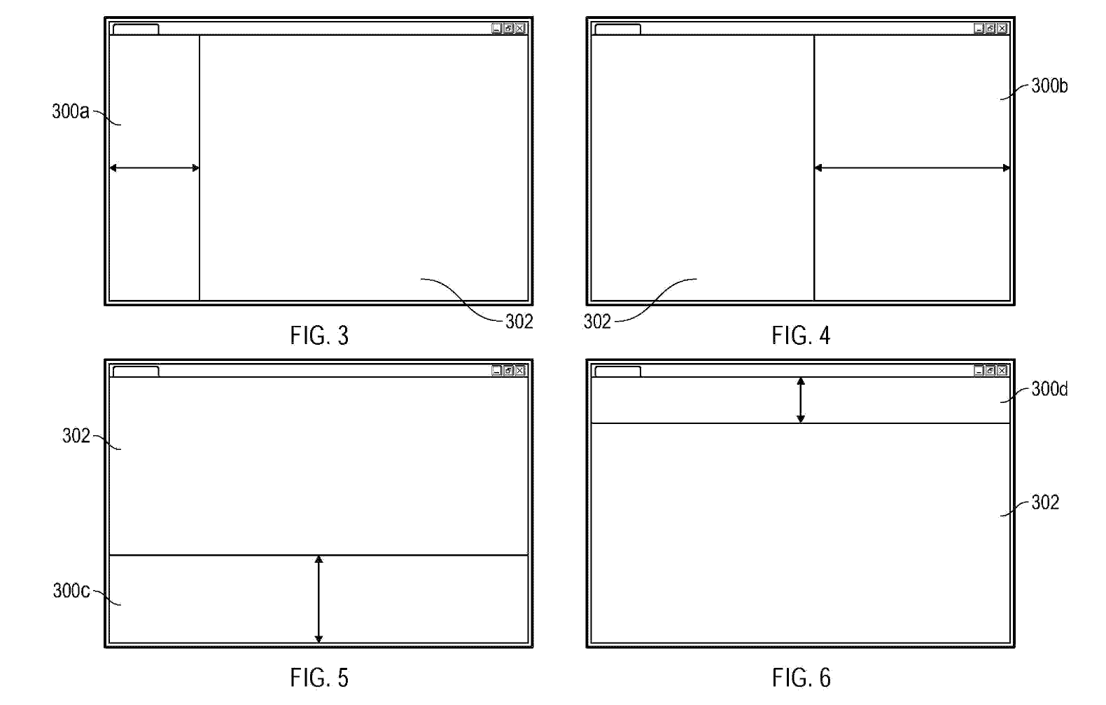

As described in more detail below, one or more display characteristics of the secondary GUI element 204 can be configured by the user. In other words, the appearance, arrangement, features, functionality, and/or other characteristics of the secondary GUI element 204 are customizable to suit the needs and desires of the user. To this end, FIGS. 3-6 are diagrams that illustrate customizable characteristics of a secondary GUI element 300 suitable for use in a GUI generated within a web browser on a client computing device in the system 100 shown in FIG. 1.

Although any number of parameters could be subjected to customization, the exemplary embodiment presented here accommodates user-configurable display regions and user-configurable display dimensions (sizing) for the secondary GUI elements. In this regard, FIG. 3 depicts a secondary GUI element 300 rendered as a sidebar component positioned on the left side of the display, relative to the primary GUI element 302. The configuration data corresponding to the secondary GUI element 300a defines a relatively narrow width as a display dimension for the secondary GUI element 300a. As illustrated in FIG. 3, the secondary GUI element 300a occupies approximately 25% of the overall width of the display. In contrast, FIG. 4 depicts the secondary GUI element 300b located on the right side of the primary GUI element 302 and having a relatively expansive width as a display dimension. As shown in FIG. 4, the secondary GUI element 300b occupies about 45% of the overall width of the display. In certain embodiments, the configuration data can be provided to designate an upper or lower component rather than a sidebar component. FIG. 5 depicts one example where the secondary GUI element 300c is positioned in a lower display region, relative to the primary GUI element 302. For the illustrated embodiment, the secondary GUI element 300c occupies about 33% of the overall height of the display. In contrast, the secondary GUI element 300d shown in FIG. 6 is a relatively short component that is located at an upper display area, relative to the primary GUI element 302.

It should be appreciated that a secondary GUI component need not span the entire width or height of the display (as shown in FIGS. 3-6). Rather, a secondary GUI component could be implemented as a rectangle, polygon, or any desired shape with any desired dimensions. Moreover, a secondary GUI component need not be positioned at or near the boundary of the screen as depicted in FIGS. 2-6. The simple examples shown here represent easy-to-deploy and uncluttered realizations that result in an overall GUI display that is intuitive and easy to read. In alternative embodiments, the secondary GUI element could be positioned anywhere relative to the primary GUI element (and the secondary GUI element could overlap or divide the primary GUI element if so desired).

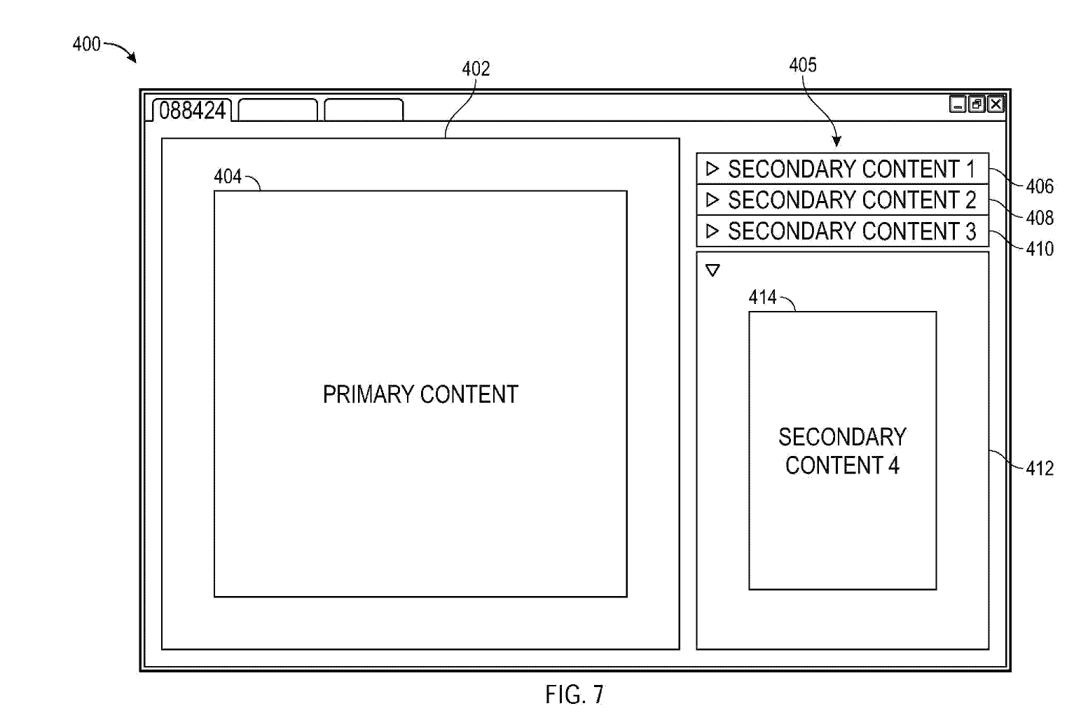

FIG. 2 illustrates one exemplary embodiment where the primary GUI element 202 has only one secondary GUI element 204 associated therewith. Alternatively, a primary GUI could have a plurality of different secondary GUIs associated therewith, where each of the secondary GUIs contain secondary content that is contextually related to or is otherwise relevant to the primary content. In this regard, FIG. 7 is a diagram that illustrates an exemplary GUI display 400 that includes a primary GUI element 402 for primary content 404, and a secondary GUI area 405 that is used for multiple secondary GUI elements 406, 408, 410, 412 for secondary content. The secondary GUI elements 406, 408, 410, 412 are arranged in a vertically expandable arrangement that allows one or more of the secondary GUI elements 406, 408, 410, 412 to be displayed or minimized as desired. FIG. 7 depicts a scenario where only the secondary GUI element 412 has been expanded for viewing of its respective secondary content 414 (labeled “Secondary Content 4”). In contrast, the secondary GUI elements 406, 408, 410 are minimized such that their associated secondary content is hidden (other than their respective titles, headings, or identifiers). User selection of a minimized secondary GUI element causes the GUI display 400 to be refreshed such that the selected secondary GUI element can be viewed. Conversely, a user-entered “Close” or “Minimize” command for an open secondary GUI element causes the GUI display 400 to be refreshed such that the associated secondary GUI element is closed/minimized.

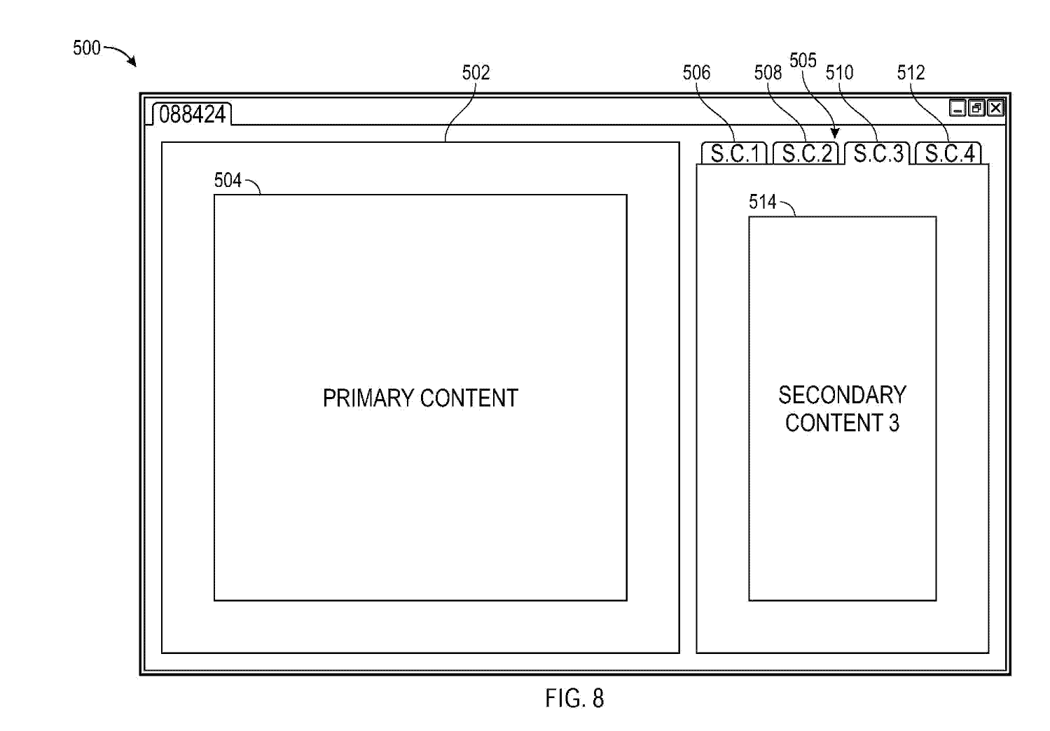

FIG. 8 is a diagram that illustrates an exemplary GUI display 500 that includes a primary GUI element 502 for primary content 504, and a secondary GUI area 505 to accommodate a plurality of secondary GUI elements 506, 508, 510, 512. In contrast to the arrangement used by the GUI display 400, the secondary GUI area 505 has the secondary GUI elements configured in a horizontal tabbed arrangement. The tabbed arrangement allows the user to switch between any of the available secondary GUI elements 506, 508, 510, 512 by clicking on the corresponding tabs, as is well understood. FIG. 8 depicts a scenario where only the secondary GUI element 510 has been selected for viewing of its respective secondary content 514 (labeled “Secondary Content 3”). In contrast, the secondary GUI elements 506, 508, 512 are hidden from view due to the focus of the secondary GUI element 510. User selection of a tabbed secondary GUI element causes the GUI display 500 to be refreshed such that the selected secondary GUI element can be viewed.

FIG. 7 and FIG. 8 are not intended to be limiting or exhaustive of the possible arrangements for multiple secondary GUI components. Indeed, an embodiment of a GUI display could support a plurality of secondary GUI elements arranged in different locations relative to the primary GUI element. For example, one secondary GUI element could be positioned at the right side of the primary GUI element, and another secondary GUI element could be positioned at the left side of the primary GUI element. The specific arrangement, positioning, and configuration of multiple secondary GUI elements may be user-configurable in certain embodiments.

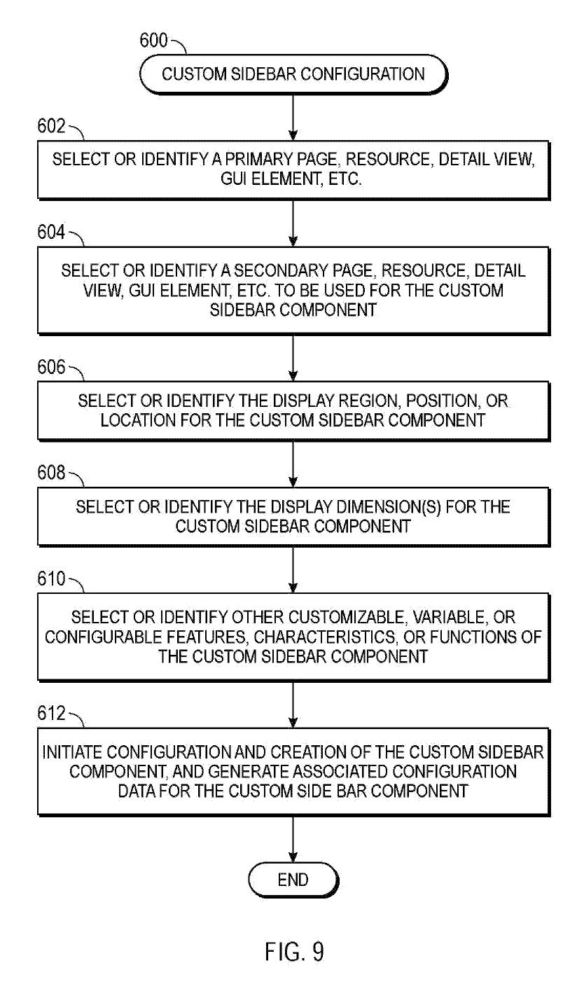

As mentioned above, it may be desirable to allow certain characteristics, features, and settings of the GUI displays to be user-configurable. In preferred exemplary embodiments, therefore, a user or a system administrator can customize and configure secondary GUI elements for use with primary GUI elements. In this regard, FIG. 9 is a flow chart that illustrates an exemplary embodiment of a custom sidebar configuration process 600 that can be performed to configure and designate preferences for a secondary GUI element. For ease of description, FIG. 9 refers to a custom sidebar component, although the process 600 could be performed for any secondary GUI element, regardless of its location on the display.

The custom sidebar configuration process 600 may begin with the selection or identification of a primary page, resource, detail view, GUI element, or any displayable feature (task 602). This example assumes that task 602 selects a primary page (e.g., a web page having a specific URL) that corresponds to, includes, or is otherwise associated with primary content to be rendered in connection with a GUI display. The process 600 may also select or identify a secondary page, resource, detail view, GUI element or any displayable feature to be used in connection with the custom sidebar component (task 604). This example assumes that task 604 selects a secondary page (e.g., a web page having a specific URL) that corresponds to, includes, or is otherwise associated with secondary content to be rendered in connection with the GUI display. Notably, the identified secondary page should be related to, associated with, or relevant to the primary page in some manner.

The process 600 may continue by selecting or identifying a display region, position, or location for the custom sidebar component (task 606). As mentioned above with reference to FIGS. 3-6, the location of the custom sidebar component can be designated relative to the primary GUI element in certain embodiments. For example, task 606 might allow the user to choose from four possible options: Left, Right, Top, or Bottom. In certain embodiments, the process 600 also selects or identifies one or more display dimensions for the custom sidebar component (task 608). As mentioned above with reference to FIGS. 3-6, at least one dimension of the custom sidebar component can be designated in certain embodiments. For example, task 608 might allow the user to define the height of a custom sidebar component that will be rendered at the top or bottom of the display, or to define the width of a custom sidebar component that will be rendered at the left or right of the display.

It should be appreciated that the process 600 may also enable the user to select or identify other customizable, variable, flexible, or configurable features, characteristics, or functions of the custom sidebar component (task 610). For example, the process 600 could support user-configurable color schemes, themes, fonts, or the like. As another example, the process 600 could allow the user to define and deploy multiple secondary GUI elements in one custom sidebar component, as explained above with reference to FIG. 7 and FIG. 8. For such an implementation, the process 600 may also allow the user to define the order of the secondary GUI elements (tabs) arranged in the secondary GUI area of the display. In addition, the process 600 could allow the user to configure the display behavior and display priority of different GUI components, including custom sidebar components. In this regard, the process 600 might allow the user to control whether or not visibility of the custom sidebar component will dominate other GUI elements (e.g., designate the custom sidebar component as “always on top” by default). As another option, a custom sidebar component could be configured such that the secondary GUI element is automatically refreshed whenever the primary GUI element is modified. A custom sidebar component could also be configured such that it generates a title and/or an icon for itself when displayed. These and/or other user configurable options may be available to the user.

In an exemplary embodiment, tasks 602, 604, 606, 608, and 610 are associated with user interaction with a client device. In particular, the process 600 can be performed in connection with the presentation of various GUI screens in a web browser running on the client device. In practice, the process 600 can be implemented as a feature of the hosted virtual application itself, such that the user can quickly and easily configure custom sidebar components for detail views, pages, and GUI components generated by the virtual application. Accordingly, the process 600 could be executed in connection with the presentation of one or more configuration screens that include fields, menus, active control buttons, and/or other GUI features that allow the user to make selections, create user-entered data, etc.

After selecting, identifying, or otherwise designating the desired configuration options and preferences, the process 600 initiates the configuration and creation of the custom sidebar component (task 612). In association with task 612, the process 600 generates the necessary configuration data for the custom sidebar component. In turn, the configuration data can be received by the system that hosts the virtual application such that the configuration data can be applied when generating and providing the custom sidebar component for rendering at the client device. In this regard, the user-specified configuration data may be sent from the client device (e.g., as a completed browser-based form or document) to a server device for processing and implementation as needed. As described above, the user-specified configuration data defines or determines certain display characteristics of the custom sidebar component, including, without limitation: the display region for the custom sidebar component, relative to the primary GUI element; and the designated display dimension(s) for the custom sidebar component. Moreover, the user-entered configuration data may identify a primary GUI element, a primary page, and/or primary content (from any number of possible candidates) for purposes of linking to the custom sidebar component. In this regard, at least one variable display characteristic or feature of the custom sidebar component is defined or influenced by the user-specified configuration data.

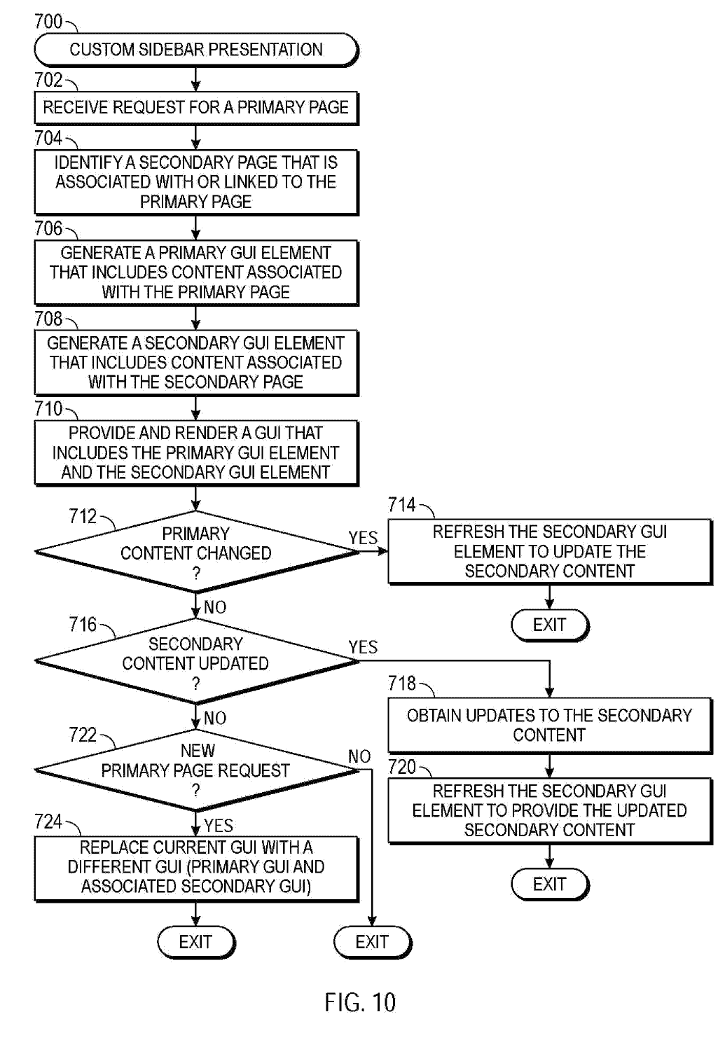

FIG. 10 is a flow chart that illustrates an exemplary embodiment of a custom sidebar presentation process 700. The process 700 assumes that a custom sidebar has already been configured and implemented (for example, in the manner described above). The process 700 begins by receiving a request for a primary page or resource of a web-based application (task 702), where the primary page has primary content associated therewith. Task 702 may be associated with an HTTP request issued by a web browser application resident at a client device, where the requested primary page has a URL or an IP address associated therewith. The web browser may be directed to a particular address or location on a primary domain to enable the web browser to download, retrieve, or otherwise access the identified primary page (or HTML document) maintained at the addressed location on the primary domain.

In response to the request for the primary page, the process 700 identifies or retrieves a secondary page of the web-based application that is associated with, linked to, or otherwise paired with the requested primary page (task 704). The secondary page includes or is associated with secondary content that is contextually related to the primary content of the primary page. The process 700 may continue by generating a GUI (e.g., a web page) for display at the user device. To this end, the illustrated embodiment of the process 700 generates a primary GUI element that includes at least some of the primary content associated with the primary page (task 706), and generates a secondary GUI element that includes at least some of the secondary content associated with the secondary page (task 708). The process 700 generates and provides an appropriate GUI (web page) that includes the primary GUI element and the secondary GUI element (task 710). In certain embodiments, this GUI is provided to the client device and rendered such that the primary and secondary GUI elements are concurrently displayed with one another.

The primary and secondary content may be static, dynamic, active, pushed, read-only, editable, etc. The specific characteristics, parameters, and behavior of the primary and secondary content may vary from one scenario to another, depending on various factors such as, without limitation: the particular functionality and purpose of the virtual application; the purpose of the primary and secondary pages; and/or the content type. The illustrated embodiment of the process 700 addresses a few common scenarios where the primary content or the secondary content may be altered. For example, if the process 700 detects changes made to the primary content (the “Yes” branch of query task 712), then the secondary GUI element could be refreshed to update the secondary content that is currently displayed (task 714). The detected changes may, for example, result from user interaction with the primary GUI element (e.g., the entry of new data, the deletion of existing data, the modification or revision of existing data, or any user-entered data that is obtained through interaction with the displayed page). Alternatively, changes to the primary content could be initiated without any user interaction. For example, the client device and/or the hosting server system could initiate changes to the primary content in certain situations.

In practice, updating the secondary content is typically performed in accordance with the changes made to the primary content. In other words, changes to the secondary content are contextually related to, or otherwise influenced by, the detected changes made to the primary content. Thus, the secondary GUI is refreshed to populate the secondary GUI element with updated secondary content that tracks the updated primary content in some manner. In certain embodiments, the primary content can be updated in response to changes made to the secondary content. In other words, the primary GUI is refreshed and updated to reflect changes to the content of the secondary GUI.

The process 700 also contemplates changes or updates to the secondary content. Changes to the secondary content could be obtained from the user, from the client device, and/or from the server system as explained above with reference to the primary content. Notably, updates and changes made to the secondary content need not always be related to or responsive to updates and changes made to the primary content. In other words, updates and changes to the secondary content can be independent of updates and changes to the primary content. For example, the secondary content could be maintained and provided by a third party content source that is unaffiliated with the entity that maintains and hosts the virtual application and that maintains and provides the primary content. Accordingly, the secondary content might be updated and modified at any time, and then pushed to the secondary GUI element such that the most current secondary content is available to the user. If the process 700 detects changes or updates to the secondary content (the “Yes” branch of query task 716), then the process 718 may obtain the updates (task 718) and refresh the secondary GUI element to provide the updated secondary content (task 720).

The web-based virtual application could be designed to support the use of secondary GUI elements with any number of pages, detail views, and primary GUI elements. For this reason, the process 700 contemplates a scenario where a different primary page is requested. In this regard, if the process 700 receives a request for a new primary page of the virtual application (the “Yes” branch of query task 722), then the current GUI page is replaced with a different GUI page that includes a corresponding primary GUI element and a corresponding secondary GUI element that is linked to the new primary GUI element (task 724). The replacement GUI elements are generated, provided, and rendered as described in more detail above for the previous iteration of the process 700. Of course, different primary and secondary GUI elements can be provided and rendered in an ongoing manner as the user engages in his or her usual workflow with the web-based application.

The various tasks performed in connection with any process described above may be performed by software, hardware, firmware, or any combination thereof In practice, portions of a process may be performed by different elements of the described system, e.g., a client device, a server system, or a functional module or component thereof It should be appreciated that a described process may include any number of additional or alternative tasks, the tasks shown in the figures need not be performed in the illustrated order, and a described process may be incorporated into a more comprehensive procedure or process having additional functionality not described in detail herein. Moreover, one or more of the illustrated tasks for a particular process could be omitted from an embodiment of the process as long as the intended overall functionality remains intact.

The foregoing detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, or detailed description.

Techniques and technologies may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

When implemented in software or firmware, various elements of the systems described herein are essentially the code segments or instructions that perform the various tasks. The program or code segments can be stored in a tangible non-transitory processor-readable medium in certain embodiments. The “processor-readable medium” or “machine-readable medium” may include any medium that can store or transfer information. Examples of the processor-readable medium include an electronic circuit, a semiconductor memory device, a ROM, a flash memory, an erasable ROM (EROM), a floppy diskette, a CD-ROM, an optical disk, a hard disk, or the like.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A computer-implemented method of presenting information associated with an application, the method comprising:
providing a graphical user interface (GUI) for display at a user device, the GUI comprising a primary GUI element and a secondary GUI element, the primary GUI element populated with primary content, and the secondary GUI element populated with secondary content that is contextually related to the primary content;
detecting changes made to the primary content resulting from user interaction with the primary GUI element; and
in response to detecting the changes, refreshing the secondary GUI element to update the secondary content.

2. The method of claim 1, wherein the changes made to the primary content represent user-entered data.

3. The method of claim 1, wherein refreshing the secondary GUI element is performed to update the secondary content in accordance with the changes made to the primary content.

4. The method of claim 1, wherein the secondary GUI element comprises a hypertext markup language iframe element.

5. The method of claim 1, wherein:
the application and the primary content are associated with a first domain; and
the secondary content is associated with a second domain that is different than the first domain.

6. The method of claim 1, further comprising receiving user-specified configuration data for the secondary GUI element, the configuration data defining a display region for the secondary GUI element relative to the primary GUI element, wherein the GUI is provided in accordance with the configuration data.

7. The method of claim 1, further comprising receiving user-specified configuration data for the secondary GUI element, the configuration data defining a display dimension for the secondary GUI element, wherein the GUI is provided in accordance with the configuration data.

8. The method of claim 1, further comprising receiving user-specified configuration data for the secondary GUI element, the configuration data identifying the primary GUI element from a plurality of candidate GUI elements for linking to the secondary GUI element.

9. The method of claim 1, wherein:
the application and the primary content are provided and maintained by a first entity; and
the secondary content is provided and maintained by a second entity that is different than the first entity.

10. The method of claim 1, further comprising:
obtaining updates to the secondary content, wherein the updates to the secondary content and the changes made to the primary content are independent, resulting in updated secondary content; and
in response to obtaining the updates, refreshing the secondary GUI element to provide the updated secondary content to the user device.

11. The method of claim 1, further comprising:
detecting changes made to the secondary content; and
in response to detecting the changes made to the secondary content, refreshing the primary GUI element to update the primary content.

12. The method of claim 1, wherein:
the application is a customer relationship management (CRM) application;
the primary GUI element comprises a detail view for a database object of the CRM application; and
the secondary GUI element comprises a sidebar view associated with the database object.

13. A computer-implemented method of presenting information associated with a application, the method comprising:
receiving user-specified configuration data that associates a first page of the application with a second page of the application, the first page having primary content associated therewith and the second page having secondary content associated therewith, wherein the secondary content is contextually related to the primary content; and
providing a primary graphical user interface (GUI) element and a secondary GUI element for concurrent display at a user device, the primary GUI element populated with the primary content, and the secondary GUI element populated with the secondary content;
wherein at least one variable display characteristic of the secondary GUI element is defined by the user-specified configuration data.

14. The method of claim 13, further comprising:
obtaining user-entered updates to the primary content;
updating the secondary content in accordance with the user-entered updates, resulting in updated secondary content; and
refreshing the secondary GUI element to populate the secondary GUI element with the updated secondary content.

15. The method of claim 13, further comprising rendering the secondary GUI element in one of a plurality of different possible locations relative to the primary GUI element, wherein the one of the plurality of different possible locations is defined by the user-specified configuration data.

16. The method of claim 13, further comprising sizing the secondary GUI element in accordance with a designated display dimension, wherein the designated display dimension is defined by the user-specified configuration data.

17. The method of claim 13, wherein:
the application and the primary content are provided and maintained by a first entity; and
the secondary content is provided and maintained by a second entity that is different than the first entity.

18. The method of claim 13, further comprising:
receiving a request for a third page of the application, the third page having additional primary content associated therewith, the third page associated with a fourth page of the application, and the fourth page having additional secondary content associated therewith, wherein the additional secondary content is contextually related to the additional primary content; and
in response to receiving the request, replacing the primary GUI element and the secondary GUI element with a new GUI, the new GUI comprising a refreshed primary GUI element and a refreshed secondary GUI element, the refreshed primary GUI element populated with the additional primary content, and the refreshed secondary GUI element populated with the additional secondary content.

19. A computer system comprising a processor and a memory, wherein the memory comprises computer-executable instructions that, when executed by the processor, cause the computer system to:
receive a request for a primary page of a web-based application, the primary page having primary content associated therewith;
in response to receiving the request, identifying a secondary page of the web-based hosted application that is linked to the primary page, the secondary page having secondary content associated therewith, wherein the secondary content is contextually related to the primary content; and
generating a graphical user interface (GUI) for display at a user device, the GUI comprising a primary GUI element and a secondary GUI element, the primary GUI element populated with the primary content, and the secondary GUI element populated with the secondary content;
wherein at least one variable display characteristic of the secondary GUI element is defined by user-specified configuration data.

20. The computer system of claim 19, wherein:
the computer system is configured as a multi-tenant architecture to support a plurality of different tenants; and
the computer system hosts the web-based application for one of the plurality of different tenants.

21. The computer system of claim 19, wherein:
the web-based application and the primary content are associated with a first domain; and
the secondary content is associated with a second domain that is different than the first domain.
